(19) United States
(12) Patent Application Publication
(10) Pub. No.: US 2021/0080998 A1
(43) Pub. Date: Mar. 18, 2021

(54) ELECTRONIC APPARATUS HAVING A STORAGE COMPARTMENT FOR STOWING A STYLUS PEN

(71) Applicant: LENOVO (SINGAPORE) PTE. LTD., Singapore (SG)

(72) Inventor: Yoshihito Nakagaki, Kanagawa (JP)

(21) Appl. No.: 17/022,715

(22) Filed: Sep. 16, 2020

(30) Foreign Application Priority Data
Sep. 17, 2019 (JP) 2019-168303

(51) Int. Cl. G06F 1/16; G06F 3/0354

(52) U.S. Cl. CPC G06F 1/1607; G06F 1/1684; G06F 3/03545

(57) ABSTRACT

An electronic apparatus having a storage compartment for stowing a stylus pen is described. The electronic apparatus includes a first and second chassis rotationally coupled to each other. The first chassis includes an opening having a side-face opening formed in a side face, and a cover opening linked with the side-face opening. The first chassis also includes a pen storage unit disposed within the opening. Inserted in the pen storage unit is a pen member that can be freely taken out from the pen storage unit. The pen member includes a pen body stowed in the pen storage unit, and a take-out operation part projects from an outer peripheral face of the pen body outward in a radial direction orthogonal to a central axis of the pen member. The take-out operation part is disposed in a cover opening.

### PRIORITY CLAIM

The present application claims benefit of priority under 35 U.S.C. §§ 120, 365 to the previously filed Japanese Patent Application No. JP2019-168303 with a priority date of Sep. 17, 2019, which is incorporated by reference herein.

### TECHNICAL FIELD

The present invention relates to electronic apparatuses in general, and in particular to an electronic apparatus having a storage compartment for stowing a stylus pen.

### BACKGROUND

The present disclosure provides an electronic apparatus having a storage compartment for stowing a stylus pen such that the stylus pen can be easily taken out from the storage compartment when needed.

### SUMMARY

In accordance with an embodiment of the present disclosure, an electronic apparatus includes a first and second chassis rotationally coupled to each other. The first chassis includes an opening having a side-face opening formed in a side face, and a cover opening linked with the side-face opening. The first chassis also includes a pen storage unit disposed within the opening. Inserted in the pen storage unit is a pen member that can be freely taken out from the pen storage unit. The pen member includes a pen body stowed in the pen storage unit, and a take-out operation part projects from an outer peripheral face of the pen body outward in a radial direction orthogonal to a central axis of the pen member. The take-out operation part is disposed in a cover opening.

All features and advantages of the present disclosure will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view of a part of an electronic apparatus according to a first embodiment;

FIG. 2 is a bottom view of an internal layout of a first chassis of the electronic apparatus from FIG. 1;

FIG. 3 is a perspective view of a pen storage unit and a pen member;

FIG. 4 is a cross-sectional diagram of an IV-IV section in FIG. 2, in which illustration of the first chassis is omitted:

FIG. 5 is a top view of the pen member from FIG. 3;

FIG. 6 is a side view of the pen member from FIG. 3;

FIG. 7 is a perspective view of a state when the pen member has been partially taken out from the pen storage unit;

FIG. 8 is a perspective view of a state when the pen member has been completely taken out from the pen storage unit;

FIG. 9 is a bottom view of a state when the pen member has been taken out from the pen storage unit;

FIG. 10 is a perspective view a part of an electronic apparatus according to a second embodiment;

FIG. 11 is a top view of a pen storage unit and a pen member from FIG. 10;

FIG. 12 is a cross-sectional diagram of an XII-XII section in FIG. 11, in which illustration of the first chassis is omitted;

FIG. 13 is a perspective view of the pen member being partially taken out from the pen storage unit;

FIG. 14 is a partial top view of a state that the pen member has been taken out from the pen storage unit;

FIG. 15 is a perspective view of a state where the pen member has been taken out from the pen storage unit;

FIG. 16 is a top view of a pen storage unit and a pen member in a first modified example of the electronic apparatus according to the second embodiment;

FIG. 17 is a cross-sectional diagram of an XVII-XVII section in FIG. 16, in which illustration of the first chassis is omitted;

FIG. 18 is a partial top view of the pen member being taken out from the pen storage unit;

FIG. 19 is a top view of a pen storage unit and a pen member in a second modified example of the electronic apparatus according to the second embodiment:

FIG. 20 is a cross-sectional view of an XX-XX section in FIG. 19, in which illustration of the first chassis is omitted; and

FIG. 21 is a partial top view of the pen member being taken out from the pen storage unit.

### DETAILED DESCRIPTION

### I. First Embodiment

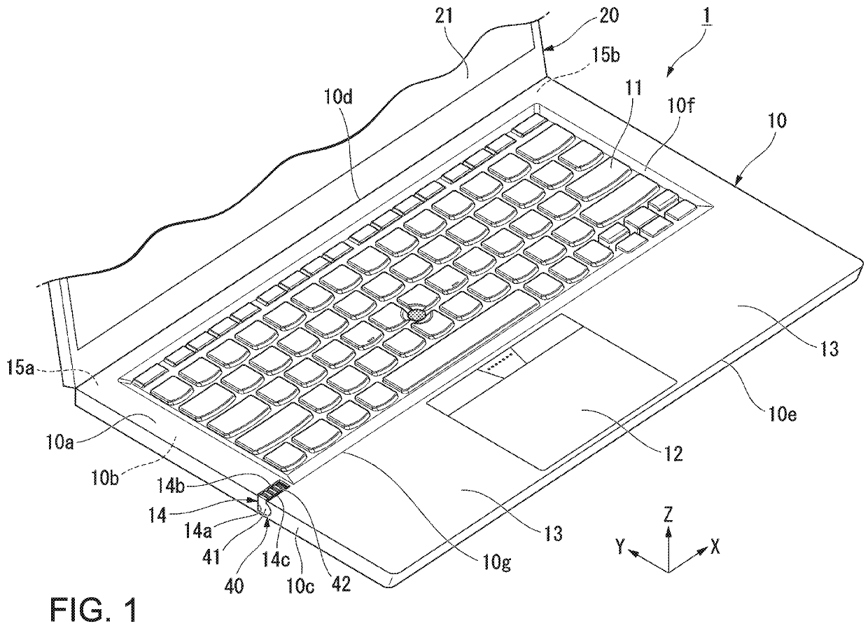

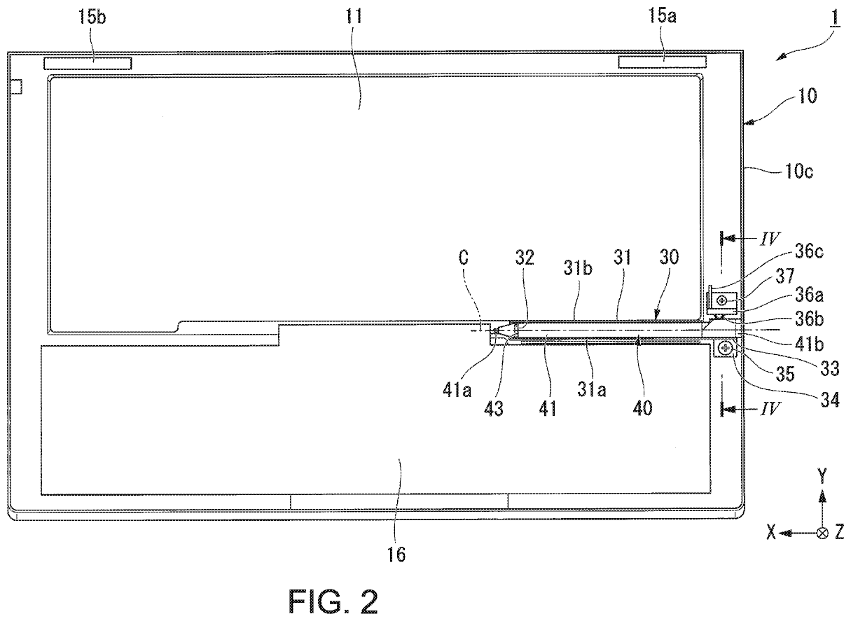

As illustrated in FIG. 1, the electronic apparatus 1 according to the first embodiment is a so-called clamshell-shape (laptop) personal computer. As illustrated in FIG. 1 and FIG. 2, the electronic apparatus 1 includes a first chassis 10, a second chassis 20 which is connected with the first chassis 10 to be rotationally movable and hinges 15a and 15b. The first chassis 10 and the second chassis 20 are coupled to each other to be mutually rotationally movable via the hinges 15a and 15b. The first chassis 10 and the second chassis 20 are disposed to be relatively movable between a closed state and an opened state around a hinge axis of the hinges 15a and 15b. FIG. 1 illustrates one example of a state where the first chassis 10 and the second chassis 20 are mutually moved around the hinge axis of the hinges 15a and 15b and then are mutually opened at an obtuse angle. FIG. 2 illustrates one example of a state where the first chassis 10 and the second chassis 20 are mutually moved around the hinge axis of the hinges 15a and 15b and then are mutually closed at a zero-degree angle. Incidentally, FIG. 2 is a bottom view of the electronic apparatus 1, in which illustration of a second cover 10b and so forth which will be described later is omitted.

The first chassis 10 is plate-shaped in external form. The first chassis 10 is square plate-shaped or flat and rectangular parallelepiped in external appearance and is in the form of a box in which a storage space is prepared. As illustrated in FIG. 1, the first chassis 10 has a first cover 10a, a second cover 10b, side faces 10c, a keyboard 11, a touch pad 12, a palm rest part 13 and an opening 14.

The first cover 10a and the second cover 10b configure a front face and a back face which face a thickness direction of the first chassis 10 in outer faces of the first chassis 10. That is, the first cover 10a and the second cover 10b face the mutually opposite sides in the thickness direction of the first chassis 10. Specifically, the first cover 10a configures the front face and the second cover 10b configures the back face in the outer faces of the first chassis 10.

The first cover 10a confronts a display 21 (which will be described later) which is disposed on the second chassis 20 in a state where the first chassis 10 and the second chassis 20 are mutually moved around the hinge axis of the hinges 15a and 15b and then are mutually closed at the zero-degree angle. That is, the first cover 10a faces the thickness direction of the first chassis 10 and freely confronts the display 21.

The first cover 10a has a dish part 10f. The dish part 10f has an opening in which keys of the keyboard 11 are disposed. That is, the keyboard 11 is disposed in the dish part 10f. The dish part 10f is square in shape in a planar view when viewing from the thickness direction. The dish part 10f has four sides 10g on a peripheral edge thereof. Each side 10g configures part of the peripheral wedge of the dish part 10f.

The second cover 10b faces the side which is opposite to the side that the first cover 10a faces in the thickness direction. The second cover 10b faces a direction which is opposite to a direction that the display 21 is disposed in a state where the first chassis 10 and the second chassis 20 are mutually moved around the hinge axis of the hinges 15a and 15b and then are mutually closed at the zero-degree angle.

The side faces 10c face a direction which is orthogonal to the thickness direction in the outer faces of the first chassis 10. Four side faces 10c are disposed and connect the front face and the back face of the first chassis 10 with each other, that is, connect the first cover 10a with the second cover 10b.

The keyboard 11, the touch pad 12, the palm rest part 13 and the opening 14 will be described later.

The second chassis 20 is plate-shaped in external form, is square plate-shaped or a flat and rectangular parallelepiped in external appearance and has the display 21. The display 21 is, for example, a liquid crystal display, an organic Electro Luminescence (EL) display and so forth.

One pair of the hinges 15a and 15b is disposed in a state of being separated from each other in a direction that the hinge axis extends and is configured as the first hinge 15a and the second hinge 15b respectively.

Positional relations between/among respective configurations in the embodiments of the present invention will be described by setting an XYZ orthogonal coordinate system. In the following, a direction which is set along an X-axis will be called a left-right direction, a direction which is set along a Y-axis will be called a front-rear direction and a direction which is set along a Z-axis will be called a thickness direction.

The thickness direction corresponds to the thickness direction of the first chassis 10. In the thickness direction, a direction from the first cover 10a toward the second cover 10b will be called the back-face side (−Z-side) and a direction from the second cover 10b toward the first cover 10a will be called the front-face side (+Z-side). Incidentally, in the embodiments of the present invention, the thickness direction corresponds to a top-bottom direction, the front-face side corresponds to the top and the back-face side corresponds to the bottom.

The left-right direction is a direction which is parallel with the hinge axis of the hinges 15a and 15b in directions which are orthogonal to the thickness direction. In the left-right direction, a direction from the first hinge 15a toward the second hinge 15b will be called the right (+X-side) and a direction from the second hinge 15b toward the first hinge 15a will be called the left (−X-side).

The front-rear direction is orthogonal to the hinge axis of the hinges 15a and 15b in the directions which are orthogonal to the thickness direction. That is, the front-rear direction is orthogonal to the thickness direction and the left-right direction. In four sides of an outer peripheral edge of the first cover 10a, a first side 10d on which the hinges 15a and 15b are disposed and a second side 10e which is parallel with the first side 10d and on which the hinges 15a and 15b are not disposed are disposed at mutually different positions in the front-rear direction. In the front-back direction, a direction from the first side 10d toward the second side 10e will be called the front (−Y-side) and a direction from the second side 10e toward the first side 10d will be called the rear (+Y-side).

The keyboard 11 is one of a plurality of input devices that the electronic apparatus 1 has and has the plurality of keys and a back plate. The plurality of keys is exposed to the front-face side (+Z-side) through the opening in the dish part 10f on the keyboard 11. The plurality of keys is arrayed side by side in the left-right direction and the front-rear direction. In the keyboard 11, the back plate is disposed in the first chassis 10 and supports the plurality of keys.

The touch pad 12 is one of the plurality of input devices that the electronic apparatus 1 has, is disposed on the first cover 10a and is located on the front (−Y-side) of the keyboard 11.

The palm rest part 13 is disposed on the first cover 10a, is located on the front of the keyboard 11 and one pair of the palm rest parts 13 is disposed on the left and the right of the touch pad 12.

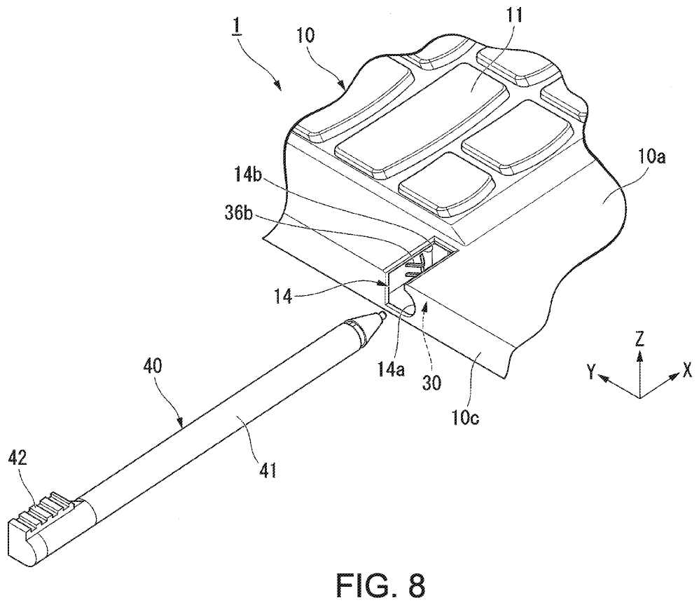

As illustrated in FIG. 1, FIG. 7 and FIG. 8, the opening 14 is a hole which is bored through an outer wall of the first chassis 10 and opens on an outer face of the first chassis 10. Specifically, the opening 14 is formed in the first chassis 10 ranging from the side faces 10c to the first cover 10a and communicates with the inside of a pen storage unit 30 which will be described later. A pen member 40 which will be described later is inserted into the opening 14.

The opening 14 has a side-face opening 14a and a cover opening 14b. The side-face opening 14a is formed in the side face 10c. The cover opening 14b is linked with the side-face opening 14a and is formed in the first cover 10a. The cover opening 14b is square in shape in the planar view when viewing from the thickness direction (Z-axis direction). A front-rear direction (Y-axis direction) length of the cover opening 14b is shorter than a front-rear direction length of the side-face opening 14a and is shorter than a left-right direction (X-axis direction) length thereof. That is, the cover opening 14b is in the form of a rectangular hole which extends in the left-right direction.

The cover opening 14b has three side 14c on a peripheral edge thereof. Each side 14c configures part of the peripheral edge of the cover opening 14b.

The side 10g which configures part of the peripheral edge of the dish part 10f and the side 14 which configures part of the peripheral edge of the cover opening 14b are located on the same virtual straight line. In the first embodiment, in the four sides 10g of the dish part 10f, one side 10g which is located on a front (−Y-side) end of the dish part 10f and extends in the left-right direction (X-axis direction) and, in the three sides 14c of the cover opening 14b, one side 14c which is located on a front end of the cover opening 14b and extends in the left-right direction are located on the same virtual straight line.

In addition, in the first embodiment, a front-rear direction opening width of the cover opening 14b and a front-rear direction width of an inclined face which is disposed on a front edge of the dish part 10f are the same as each other. The inclined face of the dish part 10f is located between the front-most key in the plurality of keys of the keyboard 11 and the side 10g which is disposed on the front end of the dish part 10f and extends in the left-right direction and is inclined toward the front-face side (+Z-side) as it goes forward.

As illustrated in FIG. 2, the electronic apparatus 1 includes a battery 16, the pen storage unit 30 and the pen member 40. The pen member 40 has a rod-like form and extends along a central axis C.

In the embodiments of the present invention, a direction that the central axis C of the pen member 40 extends will be called an axial direction. The axial direction of the central axis C is parallel with the left-right direction (X-axis direction). In the axial direction, a direction from a leading end (pen nib) 41a of the pen member 40 toward a trailing end 41b thereof will be called the trailing end side or the take-out side and a direction from the trailing end 41b toward the leading end 41a will be called the leading-end side or the insertion side. In the embodiments of the present invention, the axial-direction take-out side corresponds to the left (−X-side) and the axial-direction insertion side corresponds to the right (+X-side).

A direction which is orthogonal to the central axis C will be called a radial direction. In the radial direction, a direction which is set to approach the central axis C will be called the radial-direction inner side and a direction which is set to leave the central axis C will be called the radial-direction outer side.

A direction which is set to orbit around the central axis C will be called a circumferential direction.

The battery 16 is housed in the first chassis 10 and is disposed on part which is adjacent to the front (−Y-side) of the keyboard 11 in an inner space of the first chassis 10. The battery 16 is plate-shaped and one pair of plate faces thereof faces the thickness direction. The battery 16 has an almost rectangular plate shape and extends in the left-right direction.

The pen storage unit 30 is housed in the first chassis 10. That is, the pen storage unit 30 is disposed in the first chassis 10. The pen storage unit 30 extends between the battery 16 and the keyboard 11, that is, is disposed between the battery 16 and the keyboard 11 in the front-rear direction and extends along the axial direction of the pen member 40, that is, the left-right direction. The pen storage unit 30 extends along a side which is located on a front (−Y-side) end of the keyboard 11 and extends in the left-right direction (X-axis direction) and along a side which is located on a rear (+Y-side) end of the battery 16 and extends in the left-right direction in a bottom view of the electronic apparatus 1 which is illustrated in FIG. 2.

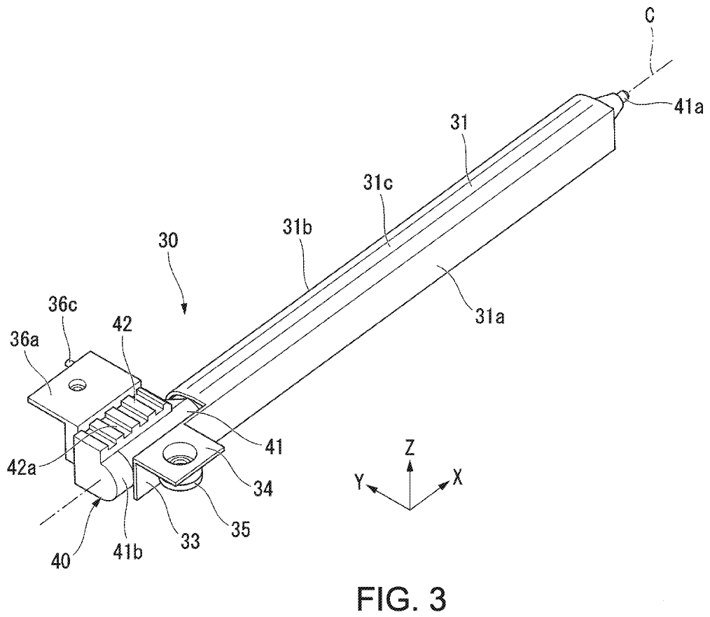

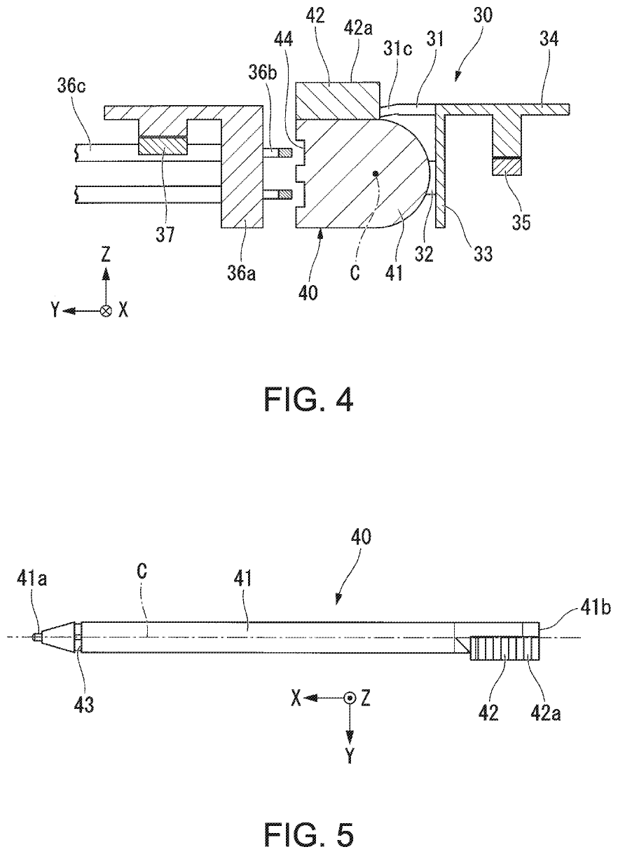

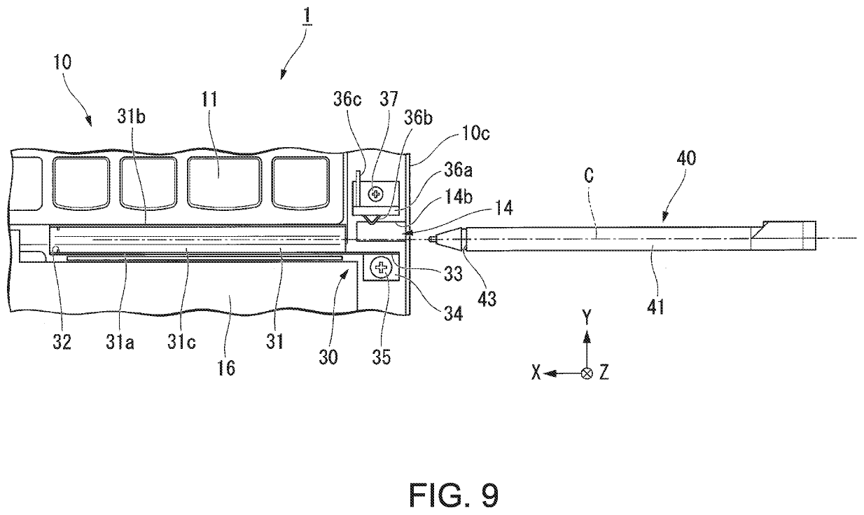

As illustrated in FIG. 3, FIG. 4 and FIG. 9, the pen storage unit 30 has a pen slot 31, a locking projection 32, a support wall 33, an attachment wall 34, a screw 36, a terminal support wall 36a, a feed terminal 36b, wiring 36c and a screw 37. The pen slot 31 houses the pen member 40 in the radial-direction inner side thereof. A pen body 41 (which will be described later) of the pen member 40 is housed in the pen slot 31.

The pen slot 31 surrounds at least part of an outer peripheral face of the pen member 40 from the radial-direction outer side. The pen slot 31 extends in the axial direction and has a U-shape which opens on the back-face side (−Z-side), that is, the bottom in section which is vertical to the central axis C.

The pen slot 31 has a first wall 31a, a second wall 31b and a third wall 31c. The first wall 31a, the second wall 31b and the third wall 31c configure parts of a peripheral wall of the pen slot 31 respectively.

The first wall 31a is plate-shaped and one pair of plate faces thereof faces the front-rear direction (Y-axis direction). The first wall 31a is located on a front (−Y-side) end of the pen slot 31 and confronts the pen member 40 which is stored in the pen storage unit 30 from the front.

The second wall 31b is plate-shaped and one pair of plate faces thereof faces the front-rear direction. The second wall 31b is located on a rear (+Y-side) end of the pen slot 31 and confronts the pen member 40 which is stored in the pen storage unit 30 from the rear.

The third wall 31c is plate-shaped and one pair of plate faces thereof faces the thickness direction (Z-axis direction). The third wall 31c is located on a front face-side (+Z-side) end, that is, a top end of the pen slot 31 and is connected with a front-face side end of the first wall 31a and a front-face side end of the second wall 31b. The third wall 31c confronts the pen member 40 which is stored in the pen storage unit 30 from the front-face side.

The locking projection 32 projects from an inner peripheral face of the pen slot 31. In the first embodiment, the locking projection 32 has a rib shape. One pair of the locking projections is disposed on the first wall 31a and the second wall 31b respectively, and projects inward in the radial direction and extends in the thickness direction, that is, in the top-bottom direction respectively. Each locking projection 32 is disposed on an axial-direction insertion-side (+X-side) end of the inner peripheral face of the pen slot 31.

The support wall 33 is plate-shaped and one pair of plate faces thereof faces the front-rear direction. The support wall 33 is disposed on the left (−X-side) beyond the pen slot 31 and is connected to a left end of the first wall 31a.

The attachment wall 34 is plate-shaped and one pair of plate faces thereof faces the thickness direction. The attachment wall 34 is connected to a front-face side end of the support wall 32 and projects from the front-face side end of the support wall 33 toward the front (−Y-side).

In the first embodiment, the pen slot 31, the support wall 33 and the attachment wall 34 are integrally formed as a single member. The pen slot 31, the support wall 33 and the attachment wall 34 are made of, for example, resin. The screw 35 fixes the attachment wall 34 to the first cover 10a. The pen slot 31, the support wall 33 and the attachment wall 34 are fixed to the first cover 10a by fixing the attachment wall 34 to the first cover 10a with the screw 35.

The terminal support wall 36a is disposed separately from the support wall 33 in the front-rear direction and is disposed on the rear (+Y-side) of the support wall 33. The terminal support wall 36a supports the feed terminal 36b and is fixed to the first cover 10a with the screw 37. A section of the terminal support wall 36a which is vertical to the central axis C is L-shaped.

The feed terminal 36b is a charging terminal for charging a secondary battery (illustration is omitted) of the pen member 40. The feed terminal 36b projects from the terminal support wall 36a toward the front (−Y-side). The feed terminal 36b is in the form of a V-shape which is protruded toward the front, viewing from the thickness direction (Z-axis direction) as illustrated in FIG. 9. As illustrated in FIG. 4, one pair of the feed terminals 36b is disposed and is arranged side by side in the thickness direction. The wiring 36c is connected to each of one pair of the feed terminals 36b.

As illustrated in FIG. 5 to FIG. 9, the pen member 40 is a member which is so-called stylus pen, digitizer pen and so forth and alternatively may be also called a pen-type input device. The pen member 40 is stored into the pen storage unit 30 to be freely taken out.

The pen member 40 has the pen body 41, a take-out operation part 42, a locking groove 43, the secondary battery which is not illustrated and a terminal 44.

The pen body 41 is columnar. A leading end of the pen body 41 is tapered such that an outer diameter is gradually reduced toward the leading end side. As illustrated in FIG. 1, FIG. 7 and FIG. 8, the pen body 41 is inserted into the pen storage unit 30 through the side-face opening 14a in the opening 14 which opens on the outer face of the first chassis 10. In the first embodiment, the pen body 41 is inserted into the pen slot 31 toward the right (+X-side) through the side-face opening 14a.

As illustrated in FIG. 3 to FIG. 6, the take-out operation part 42 is disposed on a trailing end of the pen member 40 and projects from an outer peripheral face of the pen body 41 outward in the radial direction which is orthogonal to the central axis C of the pen member 40. A front-rear direction (Y-axis direction) length of the take-out operation part 42 is shorter than a left-right direction (X-axis direction) length thereof. That is, the take-out operation part 42 extends in the left-right direction. The front-rear direction length, that is, a width of the take-out operation part 42 is shorter than an outer diameter of the pen body 41.

The take-out operation part 42 is made of a material which is softer than a material of the display 21 which is disposed on the second chassis 20 and is made of, for example, an elastomer material.

The take-out operation part 42 has an uneven anti-skid portion 42a on the outer face thereof. In the first embodiment, the anti-skid portion 42a is made uneven such that a radial-direction position changes as it goes in the axial direction.

As illustrated in FIG. 1, the take-out operation part 42 is disposed in the cover opening 14b in a state where the pen member 40 is stored into the pen storage unit 30. In the first embodiment, the take-out operation part 42 closes the cover opening 14b to be freely left open. Describing in detail, a face which faces the front-face side (+Z-side) of the take-out operation part 42, that is, the anti-skid portion 42a closes the whole cover opening 14b. The anti-skid portion 42a is exposed to the front-face side through the cover opening 14b. In the first embodiment, in the anti-skid portion 42a, an outer side face which is located on the radial-direction outer side and (the front face) of the first cover 10a are flush with each other. In addition, in FIG. 1, a rear end face of the pen body 41 and a rear end face of the take-out operation part 42 closes the side-face opening 14a to be freely left open. The rear end face of the pen body 41, the rear end face of the take-out operation part 42 and the side face 10c are flush with one another.

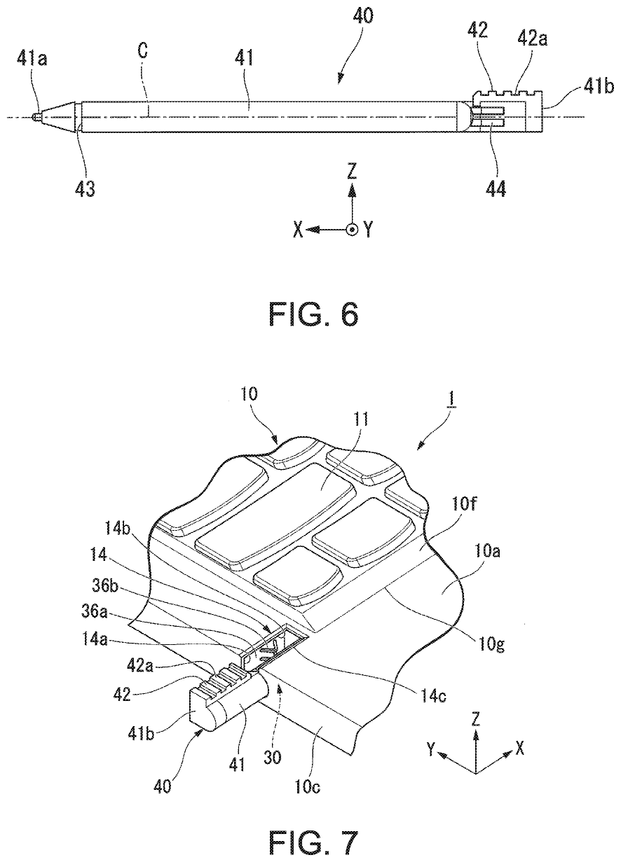

As illustrated in FIG. 5, FIG. 6 and FIG. 9, the locking groove 43 is formed in the leading end of the pen member 40, is recessed inward from the outer peripheral face of the pen body 41 in the radial direction and extends along the circumferential direction around the central axis C. The locking groove 43 is an annular groove which extends in the circumferential direction all around the pen member 41. The locking projection 32 of the pen storage unit 30 and the locking groove 43 in the pen member 40 are locked together detachably.

Although not particularly illustrated in the drawings, the secondary battery is housed in the pen member 41.

As illustrated in FIG. 4 and FIG. 6, the terminal 44 is disposed on the trailing end of the pen member 40, is exposed to the outer peripheral face of the pen body 41 and is located on a part which faces the rear (+Y-side) of the outer peripheral face of the pen body 41. The terminal 44 is electrically connected with the secondary battery which is housed in the pen member 40. One pair of the terminals 44 is disposed, is arranged side by side in the thickness direction (Z-axis direction) and comes into contact with one pair of the feed terminals 36b in a state where the pen member 40 is stored in the pen storage unit 30.

In the above described electronic apparatus 1 according to the first embodiment, the take-out operation part 42 of the pen member 40 is disposed in the cover opening 14b which is formed in the first cover 10a in the opening 14. Accordingly, it becomes easy for a user to operate the take-out operation part 42 and then to take out the pen member 40 from the pen storage unit 30.

Specifically, for example, in a case of a configuration that the take-out operation part 42 is disposed in an opening which is formed in the second cover 10b, differently from the configuration in the first embodiment, it become necessary for the user to once lift the electronic apparatus 1 so as to separate the second cover 10b from an upper face of a desk and so forth and then to take out the pen member 40 in a case of taking out the pen member 40. On the other hand, it becomes possible for the user to take out the pen member 40 in order which is illustrated in FIG. 1, FIG. 7 and FIG. 8 with no need of lifting the electronic apparatus 1 and thereby to take out the pen member 40 from the pen storage unit 30 with ease according to the first embodiment.

In addition, in the first embodiment, the pen member 40 is slidably moved in the axial direction and is taken out from the pen storage unit 30 with ease by operating the take-out operation part 42. According to the first embodiment, it becomes possible to simplify the structure of the pen storage unit 30 in comparison with, for example, a case where a take-out structure which uses a coil spring and a plurality of cylinders and which is so-called Push-Push type structure, knock mechanism and so forth, differently from the configuration of the first embodiment. Since it becomes possible to configure the pen storage unit 30 compactly, it becomes possible to reduce external dimensions of the first chassis 10 and then to promote miniaturization of the electronic apparatus 1.

In addition, in the first embodiment, since the take-out operation part 42 closes the cover opening 14b to be freely left open, it becomes possible to suppress intrusion of dust and dirt and so forth into the pen storage unit 30 through the cover opening 14b.

In addition, in the first embodiment, the take-out operation part 42 is made of the material which is softer than the material of the display 21. Therefore, in a state where the first chassis 10 and the second chassis 20 are mutually closed, that is, in a state where the first cover 10a confronts the display 21, it becomes possible to suppress damage of the display 21 even in a case where the take-out operation part 42 is in contact with the display 21.

In addition, in the first embodiment, since the take-out operation part 42 has the uneven anti-skid portion 42a, it becomes easy for the user to hook his/her finger on the take-out operation part 42 with ease and then it becomes possible for the user to operate the take-out operation part 42 stably.

In addition, in the first embodiment, the width, that is, the front-rear direction (Y-axis direction) length of the take-out operation unit 42 is shorter than the outer diameter of the pen body 41. Therefore, it becomes possible to reduce the width of the cover opening 14b conforming with the width of the take-out operation part 42. Thereby, it becomes possible to make the cover opening 14b inconspicuous. In addition, it becomes possible to suppress intrusion of the dust and dirt and so forth into the pen storage unit 30 through the cover opening 14b.

In addition, in the first embodiment, the pen storage unit 30 extends between the battery 16 and the keyboard 11. Therefore, it becomes possible to effectively utilize an interior space of the first chassis 10 and then it becomes possible to promote miniaturization of the electronic apparatus 1.

In addition, in the first embodiment, the locking projection 32 of the pen storage unit 30 and the locking groove 43 in the pen member 40 are locked together detachably. Therefore, for example, even in a posture that the electronic apparatus 1 is inclined, it becomes possible to suppress unintentional slipping-out and falling of the pen member 40 from the pen storage unit 30.

In addition, in the first embodiment, the side 10g which configures part of the peripheral edge of the dish part 10f and the side 14c which configures part of the peripheral edge of the cover opening 14b are located on the same virtual straight line. Therefore, although the cover opening 14b is formed in the first cover 10a, it becomes possible to make the cover opening 14b inconspicuous.

In addition, in the first embodiment, the front-rear direction (Y-axis direction) opening width of the cover opening 14b and the front-rear direction width of the inclined face which is disposed on the front edge of the dish part 10f are the same as each other. Therefore, it becomes possible to make the cover opening 14b more inconspicuous and then it becomes possible to favorably maintain beautiful appearance of the first cover 10a.

### II. Second Embodiment

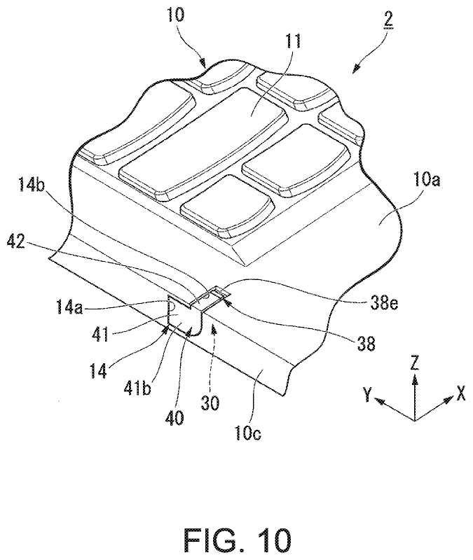

An electronic apparatus 2 according to the second embodiment will be described with reference to FIG. 10 to FIG. 15. Incidentally, in the second embodiment, the same numerals are assigned to constitutional elements which are the same as the constitutional elements of the first embodiment and description thereof is omitted.

In the electronic apparatus 2 according to the second embodiment, part of the configuration of the pen storage unit 30 and part of the configuration of the pen member 40 are different from the configurations thereof in the electronic apparatus 1 according to the first embodiment.

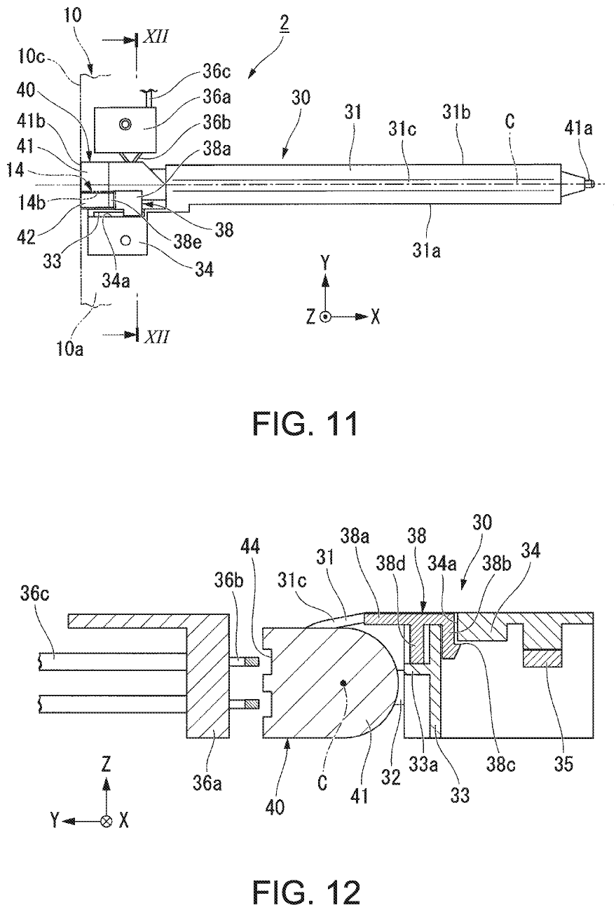

As illustrated in FIGS. 11 and 12, in the second embodiment, the attachment wall 34 of the pen storage unit 30 has a slide hole 34a. The slide hole 34a is bored through the attachment wall 34 in the thickness direction (Z-axis direction) and extends in the left-right direction (X-axis direction).

In addition, the support wall 33 of the pen storage unit 30 has a guide wall 33a. The guide wall 33a projects rearward from the plate face which faces the rear (+Y-side) of the support wall 33 and extends in the left-right direction. The guide wall 33a is plate-shaped and one pair of plate faces thereof faces the thickness direction.

In addition, the pen storage unit 30 has a shutter 38. The shutter 38 is slidably movable in the axial direction relative to the cover opening 14b and thereby freely covers and uncovers the cover opening 14b (that is, leave the cover opening 14b uncovered) and is disposed on the back-face side (−Z-side) of the first cover 10a.

The shutter 38 has a shutter body 38a, an insertion wall 38b, a locking claw 38c, a hanging-down wall 38d and an operation projection 38e.

The shutter body 38a is plate-shaped and one pair of plate faces thereof face the thickness direction (Z-axis direction). The shutter body 38a is disposed between the first cover 10a and the support wall 33 in the thickness direction. The back-face side (−Z-side) plate face of the shutter body 38a is in contact with a front-face side (+Z-side) facing end face of the support wall 33. The shutter body 38a is supported by the support wall 33 from the back-face side to be slidable. That is, the support wall 33 supports the shutter 38 from the thickness-direction back face side. The shutter body 38a is movable in the axial direction, that is, the left-right direction (X-axis direction) and covers the cover opening 14b to be freely uncovered.

The insertion wall 38b is connected to a front (−Y-side) end of the shutter body 38a, extends from the front end of the shutter body 38a toward the back-face side (−Z-side) and is inserted into the slide hole 34a from the front-face side (+Z-side).

The locking claw 38c is disposed on a back-face side end of the insertion wall 38b, projects forward from the back-face side end of the insertion wall 38b and confronts the back-face side facing plate face of the attachment wall 34 in the thickness direction (Z-axis direction).

The hanging-down wall 38d projects from the back-face side (−Z-side) facing plate face of the shutter body 38a toward the back-face side. The hanging-down wall 38d is plate-shaped and one pair of plate faces thereof faces the front-rear direction (Y-axis direction). A back-face side facing end face of the hanging-down wall 38d is in contact with or confronts the front-face side (+Z-side) facing plate face of the guide wall 33a leaving a space therebetween.

The operation projection 38e is connected to a left (−X-side) end of the shutter body 38a, projects from the left end of the shutter body 38a toward the front-face side (+Z-side) and extends in the front-rear direction (Y-axis direction). That is, the operation projection 38e projects from the shutter body 38a toward the front-face side. The operation projection 38e is plate-shaped and one pair of plate faces thereof faces the left-right direction (X-axis direction). In one pair of the plate faces of the operation projection 38e, the plate face which faces the right (+X-side), that is, the axial-direction insertion side freely comes into contact with one side 14c which is located on a right end and extends in the front-rear direction in the three sides 14c which configure the peripheral edge of the cover opening 14b. In one pair of the plate faces of the operation projection 38e, the plate face which faces the left (−X-side), that is, the axial-direction take-out side freely comes into contact with the take-out operation part 42 of the pen member 40. That is, the take-out operation part 42 freely comes into contact with the axial-direction take-out side facing plate face in one pair of the plate faces of the operation projection 38e.

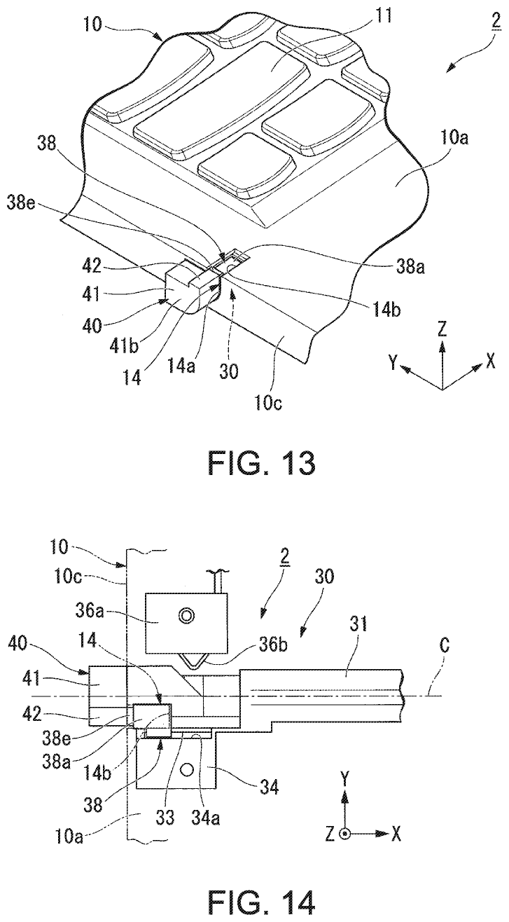

As illustrated in FIG. 10, FIG. 13, FIG. 14 and FIG. 15, in the pen member 40 according to the second embodiment, the take-out operation part 42 has no anti-skid portion 42a. In addition, the width of the take-out operation part 42, that is, the front-rear direction (Y-axis direction) length thereof is less than half of the outer diameter of the pen body 41.

According to the above-described electronic apparatus 2 of the second embodiment, it is possible to obtain the same operational effect as the aforementioned electronic apparatus 1 according to the first embodiment has.

In addition, in the second embodiment, the pen storage unit 30 has the shutter 38 which freely covers and uncovers the cover opening 14b. Accordingly, as illustrated in FIG. 15, even in a state where the pen member 40 is taken out from the pen storage unit 30, it becomes possible to cover the cover opening 14b with the shutter 38. Thereby, it becomes possible to suppress intrusion of the dust and dart and so forth into the pen storage unit 30 through the cover opening 14b. In addition, it becomes possible to favorably maintain the beautiful appearance of the first cover 10a by covering the cover opening 14b with the shutter 38.

In addition, in the second embodiment, since the shutter 38 is made slidably movable relative to the cover opening 14b in the axial direction, it becomes possible to cover and uncover the cover opening 14b by the simple structure.

In addition, in the second embodiment, since the shutter 38 has the operation projection 38e, it becomes possible for the user to perform sliding movement of the shutter 38, that is, an operation of opening and closing the shutter 38 with ease by operating the operation projection 38e.

In addition, in the second embodiment, the take-out operation part 42 freely comes into contact with the plate face of the operation projection 38e which faces the axial-direction take-out side in one pair of the plate faces of the operation projection 38e. Accordingly, as illustrated in FIG. 10, in a case where the user moves the operation projection 38e from a state where the pen member 40 is stored in the pen storage unit 30 toward the axial direction take-out side, that is, the left (−X-side), the take-out operation part 42 is pushed out toward the take-out side together with the operation projection 38e and thereby the pen member 40 is brought into a state of being freely taken out from the pen storage unit 30 as illustrated in FIG. 13 and thus it becomes possible to take out the pen member 40 from the pen storage unit 30 as illustrated in FIG. 15. In addition, in this process of performing the take-out operation, it becomes also possible to cover the cover opening 14b with the shutter 38. That is, it becomes possible to simultaneously perform taking out of the pen member 40 and covering of the cover opening 14b with the shutter 38 by performing one operation of moving the operation projection 38e to the take-out side and thus the operation is simplified.

In addition, in the second embodiment, the width of the take-out operation part 42, that is, the front-rear direction (Y-axis direction) length thereof is less than half of the outer diameter of the pen body 41. Accordingly, it becomes possible to more reduce the width of the cover opening 14b conforming with the width of the take-out operation part 42. Thereby, it becomes possible to make the cover opening 14b more inconspicuous and then it becomes possible to suppress intrusion of the dust and dirt and others into the pen storage unit 30 through the cover opening 14b.

Incidentally, the present invention is not limited to the above-mentioned embodiments and modification, alteration and so forth of the configurations are possible within the range not deviating from the gist of the present invention, for example, as will be described in the following.

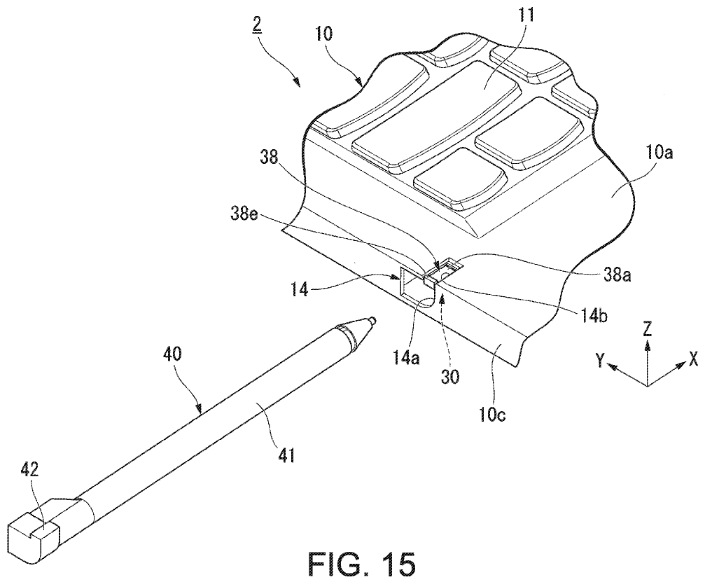

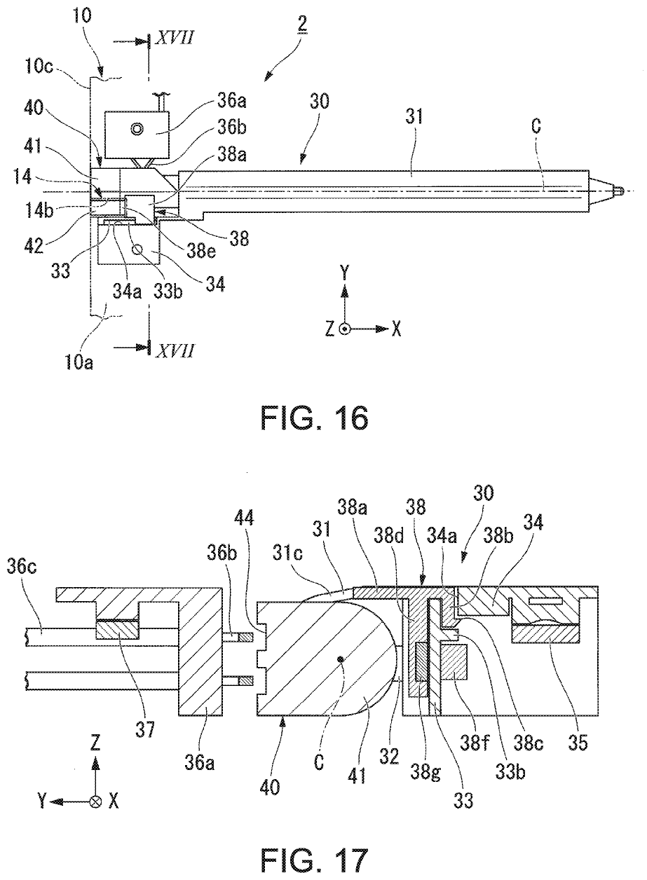

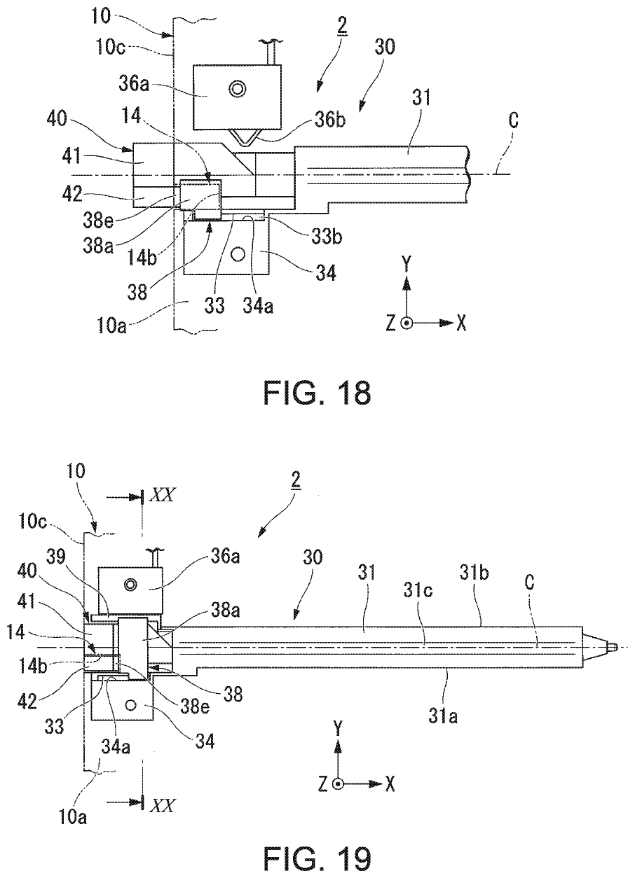

FIG. 16 to FIG. 18 illustrate a first modified example of the electronic apparatus 2 according to the second embodiment. In the first modified example, an axial-direction position of the shutter 38 relative to the cover opening 14b is retained with magnetic force. That is, in a case where force which exceeds a predetermined value acts on the shutter 38 in the axial direction, it becomes possible for the shutter 38 to move in the axial direction. The shutter 38 has a magnet 38f and a magnetic material 38g.

The magnet 38f is disposed on the front (−Y-side) facing plate face of the support wall 33 and extends in the left-right direction (X-axis direction).

The magnetic material 38g is, for example, an iron plate and is disposed on the front facing plate face of the hanging-down wall 38d. In the illustrated example, the magnetic material 38g is embedded in the front facing plate face of the hanging-down wall 38d. The magnet 38f and the magnetic material 38g are disposed on both sides, that is, the front (−Y-side) and the rear (+Y-side) of the support wall 33 in the front-rear direction (Y-axis direction).

The support wall 33 has a partition wall 33b. The partition wall 33b projects forward from the front facing plate face of the support wall 33 and extends in the left-right direction. The partition wall 33b is plate-shaped and one pair of plate faces thereof faces the thickness direction (Z-axis direction). The partition wall 33b partitions between the slide hole 34a and the magnet 38f in the thickness direction.

According to the first modified example, the axial-direction position of the shutter 38 relative to the cover opening 14b is retained with the magnetic force. Therefore, for example, even in a posture that the electronic apparatus 2 is inclined, it becomes possible to suppress occurrence of such a situation that the shutter 38 is opened unintentionally and the cover opening 14b is brought into an uncovered state.

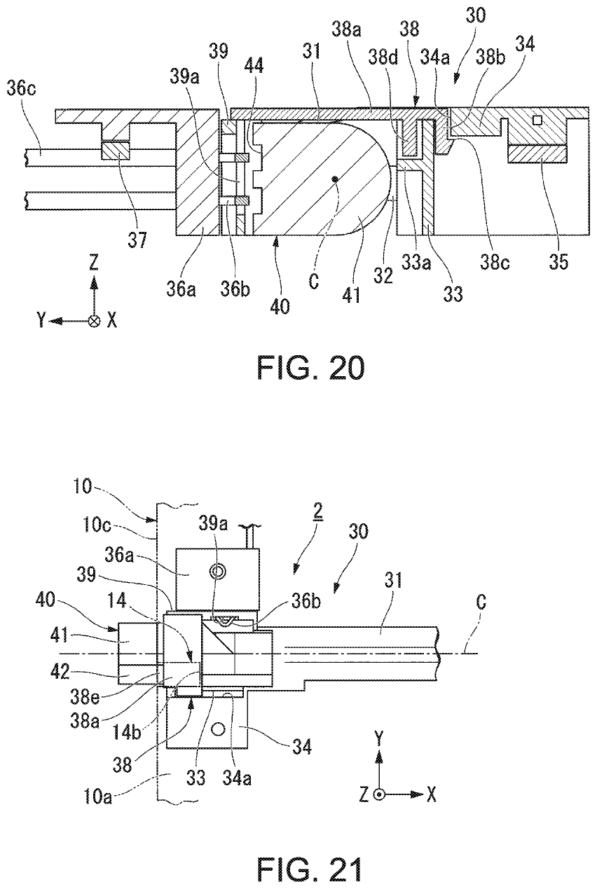

FIG. 19 to FIG. 21 illustrate a second modified example of the electronic apparatus 2 according to the second embodiment. In the second modified example, the pen storage unit 30 has one pair of support walls 33 and 39. One pair of the support walls 33 and 39 is disposed on both sides of the pen member 40 in a direction which is orthogonal to the thickness direction and the axial direction, that is, in the front-rear direction (Y-axis direction). In one pair of the support walls 33 and 39, the support wall 39 which is located on the rear (+Y-side) is plate-shaped and one pair of plate faces thereof faces the front-rear direction. The support wall 39 is disposed on the left (−X-side) beyond the pen slot 31, is connected to a left end of the second wall 31b and has a terminal insertion hole 39a. The terminal insertion hole 39a is bored through the support wall 39 in the front-rear direction. The feed terminal 36b is inserted into the terminal insertion hole 39a. The feed terminal 36b projects toward the front (−Y-side) beyond the support wall 39 through the terminal insertion hole 39a.

The shutter 38 is supported by one pair of the support walls 33 and 39 at two front-rear direction points. Specifically, a front-face side (+Z-side) facing end face of the support wall 33 and the back-face side (−Z-side) facing plate face of the shutter body 38a come into contact with each other. In addition, a front-face side facing end face of the support wall 39 and the back-face side facing plate face of the shutter body 38a come into contact with each other.

According to the second modified example, one pair of the support walls 33 and 39 of the pen storage unit 30 supports the shutter 38 on the front-rear direction both sides of the pen member 40. Accordingly, an opening/closing posture of the shutter 38 is more stabilized.

In addition, although in the second embodiment, an example that the shutter 38 is made slidably movable relative to the cover opening 14b in the axial direction is given, the configuration of the shutter 38 is not limited to the configuration in the above-mentioned example. The shutter 38 may be made swingable relative to the cover opening 14b so as to freely cover and uncover the cover opening 14b.

As has been described, the present invention provides an electronic apparatus having a storage compartment for stowing a stylus pen.

While the invention has been particularly shown and described with reference to a preferred embodiment, it will be understood by those skilled in the art that various changes in form and detail may be made therein without departing from the spirit and scope of the invention.

What is claimed is:

1. An electronic apparatus comprising:
a first and second chassis rotationally coupled to each other, wherein said first chassis includes an opening having
a side-face opening formed in a side face; and
a cover opening linked with said side-face opening;
a pen storage unit disposed within said opening;
a pen member inserted in said pen storage unit to be freely taken out from said pen storage unit, wherein said pen member includes
a pen body stowed in said pen storage unit; and
a take-out operation part projects from an outer peripheral face of said pen body outward in a radial direction orthogonal to a central axis of said pen member, wherein said take-out operation part is disposed in a cover opening.

2. The electronic apparatus of claim 1, wherein said take-out operation part closes said cover opening to be freely left open.

3. The electronic apparatus of claim 1, wherein said take-out operation part is made of a material that is softer than a material of a display in said second chassis.

4. The electronic apparatus of claim 1, wherein said take-out operation part includes an uneven anti-skid portion on an outer face thereof.

5. The electronic apparatus of claim 1, wherein a width of said take-out operation part is smaller than an outer diameter of said pen body.

6. The electronic apparatus of claim 1, wherein said first chassis includes a battery.

7. The electronic apparatus of claim 6, wherein said first chassis further includes a keyboard and said pen storage unit extends between said battery and said keyboard.

8. The electronic apparatus of claim 1, wherein said pen storage unit includes
a pen slot in which said pen body is stored; and
a locking projection projects from an inner peripheral face of said pen slot, wherein said pen member includes a locking groove recessed inward in said radial direction from said outer peripheral face of said pen body and extends along a circumferential direction around said central axis, and said looking projection and said locking groove are locked together to be detachable.

9. The electronic apparatus of claim 1, wherein said pen storage unit includes a shutter that freely covers and uncovers said cover opening.

10. The electronic apparatus of claim 9, wherein said shutter is slidably movable relative to said cover opening in an axial direction that said central axis extends.

11. The electronic apparatus of claim 9, wherein said shutter includes
a shutter body covers said cover opening part to be freely uncovered; and
an operation projection projects from said shutter body towards a front-face side in a thickness direction.

12. The electronic apparatus of claim 11, wherein said take-out operation part freely comes into contact with a face of said operation projection that faces an axial-direction take-out side.

13. The electronic apparatus of claim 9, wherein an axial-direction position of said shutter relative to said cover opening is held with magnetic force.

14. The electronic apparatus of claim 11, wherein said pen storage unit includes
a support wall that supports said shutter from said thickness-direction back-face side; and
one pair of said support walls disposed on both sides of said pen member in a direction orthogonal to said thickness direction and said axial direction.
